(19) United States
(12) Patent Application Publication
(10) Pub. No.: US 2024/0256943 A1
(43) Pub. Date: Aug. 1, 2024

(54) RECTIFYING LABELS IN TRAINING DATASETS IN MACHINE LEARNING

(71) Applicant: INTERNATIONAL BUSINESS MACHINES CORPORATION, Armonk, NY (US)

(72) Inventors: Dzung Tien PHAN, Pleasantville, NY (US); Dhavalkumar C. PATEL, White Plains, NY (US)

(21) Appl. No.: 18/103,057

(22) Filed: Jan. 30, 2023

(51) Int. Cl. G06N 20/00

(52) U.S. Cl. CPC G06N 20/00

(57) ABSTRACT

A method includes obtaining, by a processor set, labeled training data associated with a system; identifying, by the processor set, a first region and a second region in the labeled training data, wherein the first region is associated with a failure of the system and the second region is exclusive of the first region; and creating, by the processor set, re-labeled training data by altering one or more labels of the labeled training data in the first region based on data in the second region.

### BACKGROUND

Aspects of the present invention relate generally to machine learning and, more particularly, to rectifying labels in training datasets used in machine learning.

Machine learning provides computers with the ability to continue learning without being pre-programmed. Machine learning utilizes algorithms that learn from data and create insights based on the data, such as making predictions or decisions.

Training data in machine learning is the data used to train a model to solve a problem, provide relevant recommendations, perform an action, etc. Supervised learning refers to the task of inducing a learning function from a set of labeled data examples so the function can map between the input (features) and the output (target label) in the training examples. After training, the machine learning model should be able to generalize and correctly predict class labels for unseen datapoints. Machine learning models may be used for failure prediction analysis (FPA) and anomaly detection (AD), such as in industrial assets, such as pumps, wind turbines, etc., where the industrial asset is equipped with Internet of Things (IoT) sensors and the IoT sensor data is labeled and used to train the machine learning model.

### SUMMARY

In a first aspect of the invention, there is a computer-implemented method including: obtaining, by a processor set, labeled training data associated with a system; identifying, by the processor set, a first region and a second region in the labeled training data, wherein the first region is associated with a failure of the system and the second region is exclusive of the first region; and creating, by the processor set, re-labeled training data by altering one or more labels of the labeled training data in the first region based on data in the second region.

In another aspect of the invention, there is a computer program product including one or more computer readable storage media having program instructions collectively stored on the one or more computer readable storage media. The program instructions are executable to: obtain labeled training data associated with a system; identify a first region and a second region in the labeled training data, wherein the first region is associated with a failure of the system and the second region is exclusive of the first region; and create re-labeled training data by altering one or more labels of the labeled training data in the first region based on data in the second region.

In another aspect of the invention, there is a system including a processor set, one or more computer readable storage media, and program instructions collectively stored on the one or more computer readable storage media. The program instructions are executable to: obtain labeled training data associated with a system; identify a first region and a second region in the labeled training data, wherein the first region is associated with a failure of the system and the second region is exclusive of the first region; and create re-labeled training data by altering one or more labels of the labeled training data in the first region based on data in the second region.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of a technique for creating labeled training data in accordance with aspects of the present invention.

FIG. 4 shows an example of target label generation in accordance with aspects of the present invention.

FIGS. 5A-D show examples of labeling data relative to a failure point in accordance with aspects of the present invention.

FIG. 6 shows an example of maintaining label temporal consistency for noisy data in accordance with aspects of the present invention.

FIG. 7 shows a training algorithm used for training an optimization framework in accordance with aspects of the present invention.

FIG. 8 shows a flowchart of an exemplary method in accordance with aspects of the present invention.

### DETAILED DESCRIPTION

Aspects of the present invention relate generally to machine learning and, more particularly, to rectifying labels for training data into re-labeled training data in training datasets used in machine learning. The field of machine learning has assumed that the data and its labels are ready for training a machine learning model. For example, given a labeled training data set of (X,Y) where X is a data tensor and Y is labels, a machine learning model is trained to determine a function of X that predicts a label Y. The assumption of readily available X and Y has enabled tremendous progress in the machine learning field. However, AI Applications, which is a field of artificial intelligence (AI) that aims to operationalize AI for industry, has room for improvement in many aspects of data preparation, quality analysis, feature engineering, etc. So far, AI Applications has built various AI solutions, such as Failure Prediction Analysis (FPA) and Anomaly Detection (AD), to standardize the process of consuming the raw data from the source and bringing the data in at a level of maturity to start building a machine learning model. One such example is FPA for industrial assets such as pumps, wind turbines, etc.

Among the inventive insights of this disclosure, conventional techniques for generating labeled training data have a shortcoming in that the labels are not always accurate, which leads to poorly performing machine learning models. For example, labels that are generated based on regions of time relative to an identified failure may be inaccurate. One reason is that the time series data in the regions prior to the identified failure may not contain a signal that is correlated to the failure. Other reasons include silent failures and not-recorded failures. Inaccurately labeled training data produces machine learning models that have poor performance. For example, a machine learning model that is trained to predict a failure state of an industrial asset will perform poorly if the labeled training data is inaccurate in the sense that the data labeled as pre-failure has little or no correlation to the identified failure. Implementations of the present invention address this shortcoming by obtaining labeled training data in which the labels are generated based on a region relative to an identified failure, and then rectifying the labels of one or more training data points for records inside the region into re-labeled training data based on the data values of records outside the region. In this manner, implementations of the invention provide an improvement in the technical field of machine learning by providing rectified, re-labeled training data that are more accurate and, thus, provide a better performing machine learning model.

As will be understood from the present disclosure, implementations of the present invention provide a method for rectifying data labels for machine learning training data into re-labeled data labels, the method comprising: receiving system data comprising initial event labels; identifying features relevant to a failure; and altering uncertain labels related to the failure. In embodiments, the altering uncertain labels related to the failure comprises an optimization formulation including a rank-one tensor approximation multi-class classification with symmetric cross-entropy loss, selecting features relevant to the failure using a group sparsity, and measuring data similarity between two tensors using a Gaussian kernel function. In embodiments, the optimization formulation includes maintaining label temporal consistency by minimizing event label switches. In embodiments, the method further comprises training the optimization formulation using a decomposition algorithm. In embodiments, the system data comprises at least one of time-series data and tensor data. In embodiments, the method further comprises: receiving user input relevant to the initial event labels; and altering labels according to the user input.

Implementations of the invention are necessarily rooted in computer technology. For example, the steps of training a machine learning model using the rectified labeled training data and re-labeled training data and predicting a failure state of the system using operational data of the system with the machine learning model are computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. The values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as failure prediction analysis code shown at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

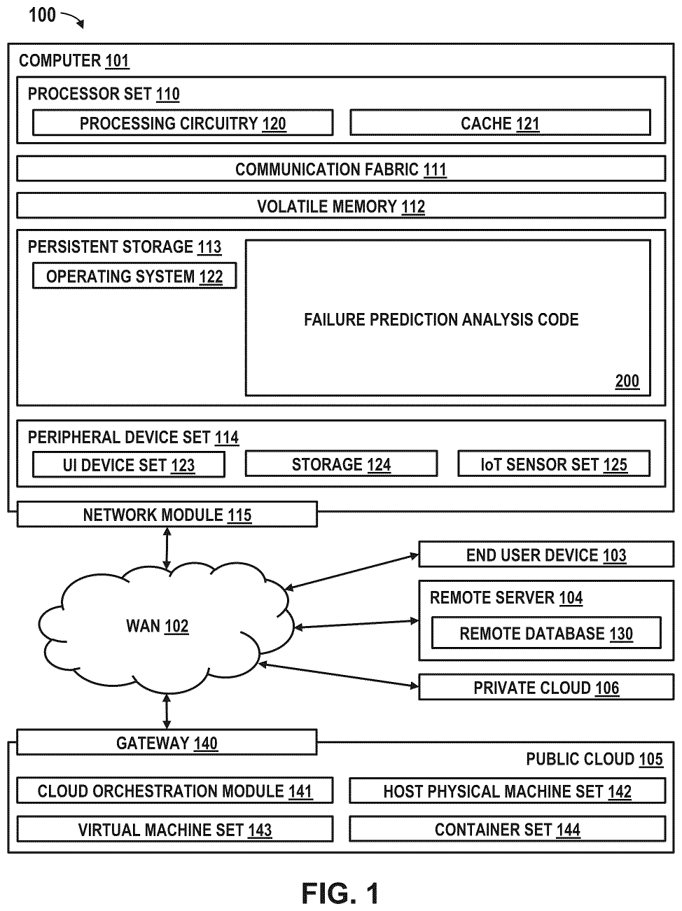

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

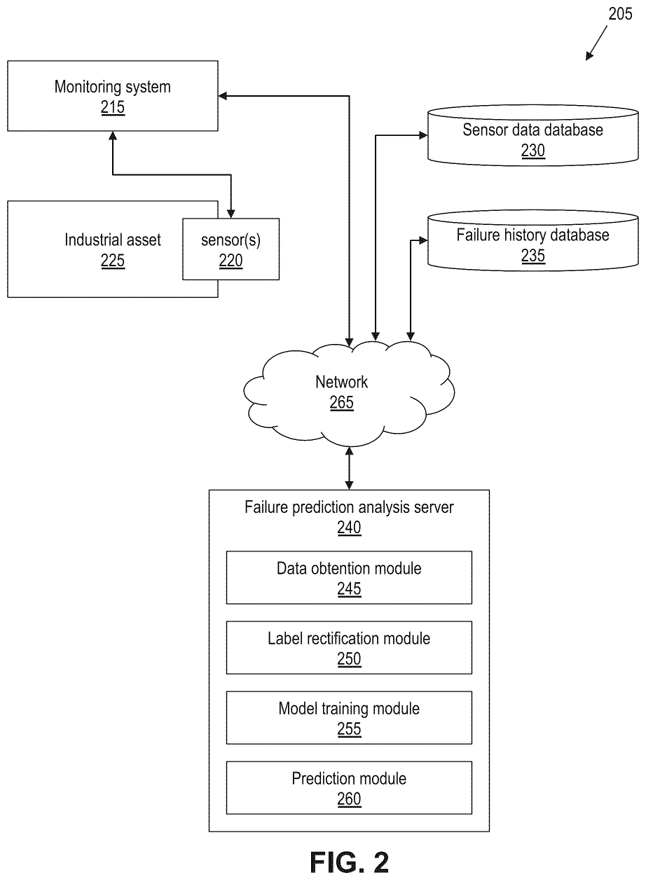

FIG. 2 shows a block diagram of an exemplary environment 205 in accordance with aspects of the invention. In embodiments, the environment 205 includes a monitoring system 215 that monitors one or more sensors 220 associated with an industrial asset 225. Non-limiting examples of the industrial asset include a pump and a wind turbine. The sensors 220 may be configured to monitor operational characteristics of the industrial asset 225, and may include, for example and without limitation, one or more sensors that detect pressure, temperature, velocity, acceleration, strain, position, and/or proximity. The sensors 220 may be mounted on or near the industrial asset 225 in an appropriate manner to detect the operational characteristics (e.g., pressure, temperature, velocity, etc.) of the industrial asset 225. The monitoring system 215 may include a computer-based system that receives data from the sensors 220 and stores the data in sensor data database 230. The data from the sensors 220 may comprise time-series data. The monitoring system 215 may also store failure history data associated with the industrial asset 225 in a failure history database 235. The failure history data may include dates and times that a failure of the industrial asset 225 occurred, amongst other failure related information. In an exemplary embodiment, the monitoring system 215 comprises a remote server 104 of FIG. 1, and the sensor data database 230 and failure history database 235 comprise instances of remote database 130 of FIG. 1.

In accordance with aspects of the invention, the environment 205 includes a failure prediction analysis server 240 that is configured to perform the inventive methods as described herein. In one example, the failure prediction analysis server 240 comprises one or more instances of the computer 101 of FIG. 1. In another example, the failure prediction analysis server 240 comprises one or more virtual machines, or one or more containers, running on one or more instances of the computer 101 of FIG. 1. In embodiments, the failure prediction analysis server 240 communicates with the monitoring system 215 and/or the databases 230, 235 via a network 265, which may comprise the WAN 102 of FIG. 1.

In embodiments, the failure prediction analysis server 240 of FIG. 2 comprises a data obtention module 245, label rectification module 250, model training module 255, and prediction module 260, each of which may comprise modules (e.g., program modules) of the code of block 200 of FIG. 1. These modules of the code of block 200 are executable by the processing circuitry 120 of FIG. 1 to perform the inventive methods as described herein. The failure prediction analysis server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

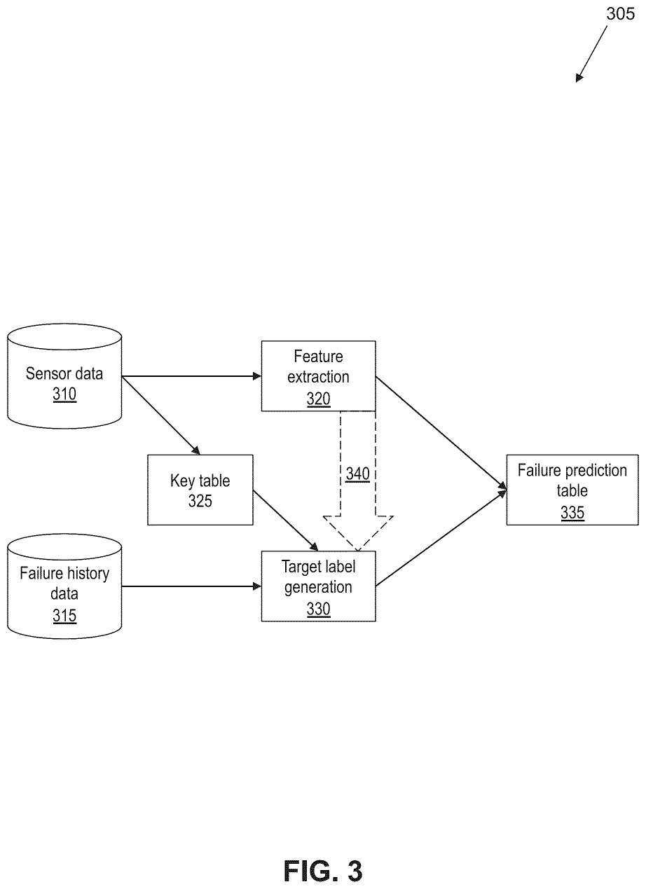

In accordance with aspects of the invention, the data obtention module 245 is configured to obtain labeled training data associated with a system. In embodiments, the system comprises the industrial asset 225 and the labeled training data comprises data pairs, wherein each data pair comprises historic data from the sensor data database 230 and a label assigned to the historic data. In one example, the data obtention module 245 creates the labeled training data using data from the sensor data database 230 and failure history database 235 and the technique described with respect to FIG. 3. In another example, another computer system creates the labeled training data using data from the sensor data database 230 and failure history database 235 and techniques such as those described with respect to FIG. 3, and the data obtention module 245 obtains the labeled training data from the other computer system, e.g., via the network 265.

In accordance with aspects of the invention, the label rectification module 250 is configured to rectify labels in the labeled training data obtained by the data obtention module 245 into re-labeled training data. In embodiments, the label rectification module 250 provides label rectification and feature selection in multi-asset failure prediction analysis with inaccurate labeling and user feedback. In embodiments, the label rectification module 250 is programmed to perform the label rectification into re-labeled training data using an optimization framework that comprises: tensor classification with canonical polyadic (CP) decomposition for structured feature inputs (e.g., tensors of any order); a symmetric cross-entropy loss and a Gaussian kernel function for measuring data similarity for handling noisy data (e.g., noisy sensor data); feature selection based on group sparsity; and an optimization algorithm comprising a decomposition algorithm to train a model.

In accordance with aspects of the invention, the model training module 255 is configured to train a machine learning model using the rectified labeled training data and re-labeled training data created by the label rectification module 250. The model training module 255 may train the machine learning model using conventional or later-developed supervised training algorithms. In one example, the machine learning model comprises an artificial neural network trained using the rectified labeled training data and/or re-labeled training data using stochastic gradient descent. Implementations of the invention are not limited to an artificial neural network, and other types of machine learning model may be created using the rectified labeled training data and/or re-labeled training data. In implementations, the model training module 255 trains the machine learning model such that the model receives input comprising operational data associated with the industrial asset 225 (e.g., data from sensors 220) and generates an output that comprises a prediction of a failure state (e.g., positive or negative) of the industrial asset 225 based on the input.

In accordance with aspects of the invention, the prediction module 260 is configured to predict a failure state of the industrial asset 225 using operational data of the industrial asset 225 with the machine learning model that was trained by the model training module 255. In embodiments, the prediction module 260 obtains operational data (e.g., sensor data from the sensors 220) from the monitoring system 215 and generates and prediction of a failure state of the industrial asset 225 by inputting the sensor data into the machine learning model.

FIG. 3 shows a block diagram of a technique 305 for creating labeled training data in accordance with aspects of the invention. In FIG. 3, sensor data 310 corresponds to sensor data stored in the sensor data database 230 of FIG. 1, and failure history data 315 corresponds to failure history data stored in the failure history database 235 of FIG. 1. Block 320 represents a feature extraction step where features are extracted from the sensor data 310 using conventional techniques. A rolling window may be applied to the sensor data 310 for performing the feature extraction, as is understood in the art. Block 325 represents creating a key table, using conventional techniques, that includes a unique asset identifier (ID) and date column for each row of the sensor data 310. As is understood in the art, the key table is used to maintain a key for the failure prediction table that will be created in a subsequent step. Block 330 represents generating a target label using conventional techniques. A future prediction window may be applied. Block 335 represents creating a failure prediction table by joining the respective features from the feature extraction at block 320 and respective labels generated at block 330. The joining may be performed using conventional techniques. In embodiments, the failure prediction table created at block 335 constitutes labeled training data that may be used to train a machine learning model. In some embodiments, the data obtention module 245 of FIG. 2 performs the feature extraction, generating the key table, generating the labels, and creating the failure prediction table at blocks 320, 325, 330, and 335. In other embodiments, another computer system (not shown) performs the feature extraction, generating the key table, generating the labels, and creating the failure prediction table at blocks 320, 325, 330, and 335, and the data obtention module 245 of FIG. 2 obtains the failure prediction table (e.g., the labeled training data) from the other computer system.

Still referring to FIG. 3, an exemplary technique for creating the failure prediction table includes performing the feature extraction (at block 320) and target label generation (at block 330) independently from one another, and then creating the failure prediction table using a join function and the key table. This exemplary technique fails to account for any insights that may be gleaned from interdependency between the extracted data and the target labels when generating the target labels. Implementations of the invention address this shortcoming by rectifying one or more of the target labels into re-labeled training data based on the data included in the extracted features, as represented by arrow 340.

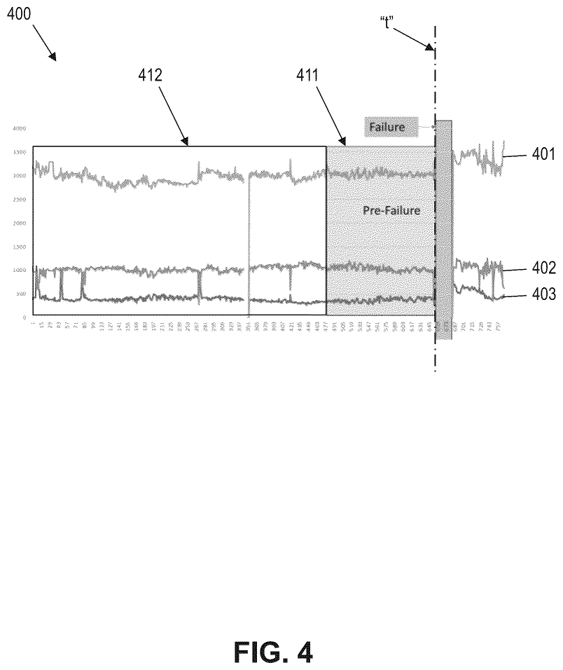

FIG. 4 shows an example of target label generation in accordance with aspects of the invention. The example of FIG. 4 shows a plot 400 of sensor data magnitude on the vertical axis versus time on the horizontal axis. In this example, the traces 401, 402, and 403 represent time series data from three different sensors, e.g., sensors 220 associated with industrial asset 225 of FIG. 2. The traces 401, 402, and 403 may constitute the sensor data 310 of FIG. 3. An exemplary technique for performing target label generation (e.g., at block 330 of FIG. 3) is to identify a failure time “t” associated with a failure (e.g., of the industrial asset 225 as defined in the failure history data), to label all records within a first region 411 prior to the failure time “t” as pre-failure, and to label all records in a second region 412 prior to the first region 411 as normal. In one example, the pre-failure records are classified as positive and the normal records are classified as negative. In FIG. 4, the first region 411 comprises an amount of time defined by a number of timestamps prior to the failure time “t”. The amount of time in the first region 411 is predefined and may comprise, for example, 30 days. In this manner, individual records (e.g., data points) of traces 401, 402, 403 within a 30-day window of time prior to the failure time “t” are labeled as pre-failure, and all other records of traces 401, 402, 403 prior to the 30-day window are labeled as normal. This technique of target label generation is based solely on the identified failure time “t” and the predefined time of the first region 411 and does not take into account any information that can be gleaned from the values of the records in the traces 401, 402, and 403. Implementations of the invention address this shortcoming by obtaining labeled training data in which the labels are generated using the technique shown in FIG. 4 and then rectifying the labels of one or more training data points for records inside the first region 411 into re-labeled training data based on the data values of records in the second region 412.

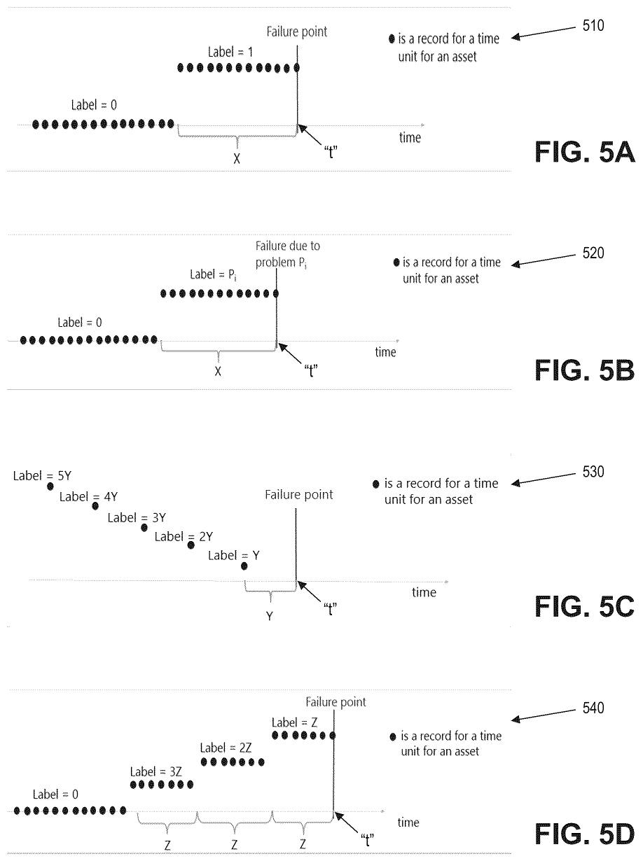

FIGS. 5A-D show examples of labeling data relative to a failure point in accordance with aspects of the invention. FIG. 5A shows an example 510 of target label generation in which the first region has a time magnitude of “X” prior to the failure time “t”. In this example, the pre-failure records (i.e., the records within the first region) are labeled with the label “1” and the normal records (i.e., the records in the second region prior to the first region) are labeled with “0”. FIG. 5B shows an example 520 of target label generation in which the first region has a time magnitude of “X” prior to the failure time “t” due to failure problem “Pi”. In this example, the pre-failure records (i.e., the records within the first region) are labeled with the label “Pi” and the normal records (i.e., the records prior to the first region) are labeled with “0”. FIG. 5C shows an example 530 of target label generation in which the first region has a time magnitude of “Y” prior to the failure time “t”. In this example, the pre-failure records (i.e., the records within the first region) are labeled with the label “Y” and the normal records (i.e., the records prior to the first region) are successively labeled with “2Y”, “3Y”, “4Y”, and “5Y”. FIG. 5D shows an example 540 of target label generation in which the range has a time magnitude of 3Z prior to the failure time “t”. In this example, records within one Z of the failure time “t” are labeled with “Z”, records within two Z of the failure time “t” are labeled with “2Z”, records within three Z of the failure time “t” are labeled with “3Z”, and the normal records are labeled with “0”.

Labels that are generated based on regions of time relative to an identified failure may be inaccurate. One reason is that the time series data in the regions prior to the identified failure may not contain a signal that is correlated to the failure. Other reasons include silent failures and not-recorded failures. Inaccurately labeled training data produces machine learning models that have poor performance. For example, a machine learning model that is trained to predict a failure state of an industrial asset will perform poorly if the labeled training data is inaccurate in the sense that the data labeled as pre-failure has little or no correlation to the identified failure. Implementations of the invention address this shortcoming by obtaining labeled training data in which the labels are generated based on a region relative to an identified failure, and then rectifying the labels of one or more training data points for records inside the region into re-labeled training data based on the data values of records outside the region. In this manner, implementations of the invention provide a label rectification method to deal with inaccurate labeling and poor performance models for multi-asset, time series-based failure prediction analysis. The method may be applied at the time of initial training of a machine learning model as well as at the time of re-training a machine learning model. As described herein, the method is configured to deal with structured feature inputs (e.g., tensors) with noise. The following paragraphs describe an optimization framework according to aspects of the invention that is usable by the label rectification module 250 of FIG. 2 to perform label rectification into re-labeled training data in the manner described herein. In embodiments, and as described herein, the optimization framework comprises: tensor classification with canonical polyadic (CP) decomposition for structured feature inputs (e.g., tensors); a symmetric cross-entropy loss and a Gaussian kernel function for measuring data similarity for handling noisy data (e.g., sensor data); feature selection based on group sparsity; and an optimization algorithm comprising a decomposition algorithm to train a model.

In the following description, X represents a data tensor, Y represents a label vector, and a C represents feedback from a user. For a set of labeled training data having N₁+N₂ number of samples, X=[X_{S}, X_{N}] where X_{S} and X_{N} are defined by equations 1 and 2:

$${X}_{S} = [ {X}_{s}^{1} , … , {X}_{s}^{{N}_{1}} ] , {X}_{s}^{i} ∈ {ℝ}^{{d}_{1} \times {d}_{2} \times … \times {d}_{M}} \qquad ( Equation 1 )$$

$${X}_{N} = [ {X}_{n}^{1} , … , {X}_{n}^{{N}_{1}} ] , {X}_{n}^{i} ∈ {ℝ}^{{d}_{1} \times {d}_{2} \times … \times {d}_{M}} \qquad ( Equation 2 )$$

In equations 1 and 2, X_{S} represents a number N₁ of M^{th} order tensor instances that happen within N₁ timestamps before the failure, and X_{N} represents a number N₂ of tensor instances deemed normal. In equations 1 and 2, dᵢ represents the i-th dimension of the tensor. In one example, X comprises data from sensor data database 230 of FIG. 2, X_{S} is the N₁ number of instances of X that are in the first region 411 of FIG. 4, and X_{N} is the N₂ number of instances of X that are in the second region 412 of FIG. 4. In equations 1 and 2, when M=1, the feature inputs Xₛⁱ, Xₙⁱ are vectors. In equations 1 and 2, when M=2, the feature inputs Xₛⁱ, Xₙⁱ are matrices. In embodiments, the dataset includes K event cases from one specific failure node, e.g., one identified failure such as at time “t” in FIG. 4.

In embodiments, the initial event labels Y^{init} associated with the data tensor X are defined in equation 3.

$${Y}^{init} = [ {Y}_{S}^{init} , {Y}_{N}^{init} ] ∈ {\{ 0 , 1 \}}^{K \times ( {N}_{1} + {N}_{2} )} \qquad ( Equation 3 )$$

In equation 3, Yₛ^{init} represents the initial labels of records X_{S} in a pre-failure region such as first region 411 of FIG. 4, and Y_{N}^{init} represents the initial labels of records X_{N} in a normal region such as region 412 of FIG. 4. In equation 3, the sum of each column is equal to 1. A unique “1” entry for each column of Y represents the initial event label of each instance of X. In embodiments, the optimization framework is configured such that Y_{S}(i,j)=1 for some i<K if X_{S}(j)=Xₛ^{j} is related to the failure at the i^{th} event. For the normal instance in Xₙ it follows that Y_{N}(K,j)=1. In accordance with aspects of the invention, the optimization framework is configured to identify instances in X_{S} that are relevant to the identified failure and associated features. In accordance with aspects of the invention, the optimization framework is configured to rectify one or more of the initial labels into re-labeled training data by changing one or more of the labels in Yₛ^{init} while keeping the Y_{N}^{init} labels unchanged. In embodiments, the result of the label rectification is a new label matrix [Y_{S}, Y_{N}^{init}] that may be combined with data tensor X=[X_{S}, X_{N}] to create re-labeled training data that may be used to train a machine learning model.

In accordance with aspects of the invention, the optimization framework includes tensor classification with feature selection. In embodiments, the tensor classification with feature selection comprises using a mapping function to estimate a probability of a label for a given tensor input. In one example, for a tensor input X′, the optimization framework uses the mapping h_{W}(Xⁱ) to estimate the probability P(Yᵢ(k)|Xⁱ) according to equation 4:

$${h}_{W} ( {𝒳}^{i} ) = [ \begin{matrix}P ( Y ( 1 ) = 1 \vert {𝒳}^{i} ; W ) \\ P ( Y ( 2 ) = 1 \vert {𝒳}^{i} ; W ) \\ … \\ P ( Y ( K ) = 1 \vert {𝒳}^{i} ; W )\end{matrix} ] = \frac{1}{{\sum }_{k = 1}^{K} {e}^{〈 {W}_{k} , {𝒳}^{i} 〉}} [ \begin{matrix}{e}^{〈 {W}_{1} , {𝒳}^{i} 〉} \\ {e}^{〈 {W}_{2} , {𝒳}^{i} 〉} \\ … \\ {e}^{〈 {W}_{K} , {𝒳}^{i} 〉}\end{matrix} ] \qquad ( Equation 4 )$$

In equation 4, P(Yᵢ(k)|Xⁱ) represents the probability that the label Yᵢ is k for data instance Xⁱ, where k is between 1 and K, and where K is the number of different labels available. In equation 4, Wᵢ represents a weight tensor used for feature selection. In embodiments, the optimization framework uses a compact representation for Wᵢ via rank-one tensors approximation and group sparsity. In equation 4, [symbol] W, X [symbol] represents the dot product between two tensors W and X. In embodiments, the weight tensor Wᵢ is approximated by a rank-R tensor using canonical polyadic (CP) decomposition as shown in equation 5.

$${W}_{i} \approx {\sum }_{r = 1}^{R} {a}_{r}^{1} ∘ {a}_{r}^{2} ∘ … ∘ {a}_{r}^{M} \qquad ( Equation 5 )$$

In equation 5, R is a positive integer and aᵣⁱ∈ [symbol] ^{d}^{ᵢ} is a set of vectors determined in the optimization training process.

In embodiments, a first level of label correction and feature selection is modeled using equation 6, which includes the mapping h_{W}(Xⁱ) of equation 4 and the weight tensor Wᵢ of equation 5.

$$ℒ ( Y , {h}_{W} ( 𝒳 ) ) = {\sum }_{j = 1}^{{N}_{1}} {ℓ}_{S} ( {Y}_{S} ( : , j ) , {h}_{W} ( {𝒳}_{S}^{j} ) ) + {\sum }_{j = 1}^{{N}_{2}} {ℓ}_{N} ( {Y}_{N} ( : , j ) , {h}_{N} ( {𝒳}_{N}^{j} ) ) + {α}_{1} {\sum }_{k = 1}^{K} {‖ {W}_{k} - {\sum }_{r = 1}^{R} {a}_{k , r}^{1} ∘ {a}_{k , r}^{2} ∘ … ∘ {a}_{k , r}^{M} ‖}^{2} + {α}_{2} {\sum }_{k = 1}^{K} {‖ {W}_{k} ‖}_{1 , 2} \qquad ( Equation 6 )$$

In equation 6, α₁ and α₂ are positive model parameters determined during the training process using parameter tuning, and ∥.∥_{1,2} is the l_{1,2} norm.

In embodiments, because both Y_{S}(:,j) and h_{W}(X_{S}^{j}) are unknown in equation 6, the optimization framework uses a symmetric cross-entropy loss for [symbol] _{S} in equation 6. The symmetric cross-entropy loss is shown in equation 7.

$${ℓ}_{S} ( {Y}_{S} ( : , j ) , {h}_{W} ( {𝒳}_{S}^{j} ) ) = 0.5 ( H ( y , \hat{y} ) + H ( \hat{y} , y ) ) \qquad ( Equation 7 )$$

In equation 7, H(y,ŷ) is the cross-entropy between two distributions y=Y_{S}(:,j) and ŷ=h_{W}(X_{S}^{j}). By using the symmetric cross-entropy loss of equation 7, [symbol] _{S} in equation 6 can be re-written as shown in equation 8:

$${ℓ}_{S} ( {Y}_{S} ( : , j ) , {h}_{W} ( {𝒳}_{S}^{j} ) ) = 0.5 {\sum }_{k = 1}^{K} ( {Y}_{S} ( k , j ) log ( {[ {h}_{W} ( {𝒳}_{S}^{j} ) ]}_{k} ) + {log ( {Y}_{S} ( k , h ) ) [ {h}_{W} ( {𝒳}_{S}^{j} ) ]}_{k} ) \qquad ( Equation 8 )$$

In embodiments, the initial labels of records X_{N} in a normal region (e.g., such as region 412 of FIG. 4) are not changed during the label rectification process into re-labeled training data. As a result, the labels of the normal instances are fixed such that Y_{N}=Y_{N}^{init}. Based on this, the optimization framework uses regular cross-entropy loss for [symbol] _{N} in equation 6. The regular cross-entropy loss is shown in equation 9.

$${ℓ}_{S} ( {Y}_{S} ( : , j ) , {h}_{N} ( {𝒳}_{N}^{j} ) ) = H ( y , \hat{y} ) = {\sum }_{k = 1}^{K} {Y}_{N}^{init} ( k , j ) log ( {[ {h}_{W} ( {𝒳}_{S}^{j} ) ]}_{k} ) \qquad ( Equation 9 )$$

In embodiments, the right side of equation 8 is used for the [symbol] _{S}( . . . ) function of equation 6, and the right side of equation 9 is used for the [symbol] _{N}( . . . ) function of equation 6.

In accordance with aspects of the invention, the optimization framework uses Gaussian kernel function for measuring data similarity. In embodiments, the optimization framework performs the label rectification into re-labeled training data by determining data similarity between instances X_{S} and X_{N} by using a Gaussian kernel function with model parameter σ to measure data similarity between two tensors according to equation 10.

$${S}_{ij} = exp ( - \frac{{〈 {𝒳}^{i} , {𝒳}^{j} 〉}^{2}}{2 {σ}^{2}} ) \qquad ( Equation 10 )$$

In embodiments, the data similarity is determined using equation 10 combined with loss components as shown in equation 11.

$${\sum }_{i = 1}^{{N}_{1}} {\sum }_{j = 1}^{{N}_{2}} ( {S}_{ij} - exp ( - \frac{{〈 {𝒳}^{i} , {𝒳}^{j} 〉}^{2}}{2 {σ}^{2}} ) ) + {α}_{3} {‖ {Y}_{S} - {Y}_{S}^{init} ‖}_{F}^{2} + {α}_{4} {\sum }_{i , j} {S}_{i , j} {‖ {Y}_{S} ( : , i ) - {Y}_{N}^{init} ( : , j ) ‖}^{2} \qquad ( Equation 11 )$$

In equation 11, α₃ and α₄ are positive model parameters determined during the training process using parameter tuning.

In embodiments, by using equation 11, the optimization framework uses determined similarity between data in the first region 411 and data in the second region 412 when determining whether to change a label of a data instances in the first region. In implementations, the optimization framework is configured to be less likely to change a label of a data instance in the first region if that data instance is less similar to data in the second region, and more likely to change a label of a data instance in the first region if that data instance is more similar to data in the second region.

Equation 12 shows the optimization framework in accordance with aspects of the invention.

$$min {\sum }_{j = 1}^{{N}_{1}} {ℓ}_{S} ( {Y}_{S} ( : , j ) , {h}_{W} ( {𝒳}_{S}^{j} ) ) + {\sum }_{j = 1}^{{N}_{2}} {ℓ}_{N} ( {Y}_{N} ( : , j ) , {h}_{N} ( {𝒳}_{N}^{j} ) ) + {α}_{1} {\sum }_{k = 1}^{K} {‖ {W}_{k} - {\sum }_{r = 1}^{R} {a}_{k , r}^{1} ∘ {a}_{k , r}^{2} ∘ … ∘ {a}_{k , r}^{M} ‖}^{2} + {α}_{2} {\sum }_{k = 1}^{K} {‖ {W}_{k} ‖}_{1 , 2} + {α}_{3} {\sum }_{i = 1}^{{N}_{1}} {\sum }_{j = 1}^{{N}_{2}} {( {S}_{ij} - exp ( - \frac{{〈 {𝒳}^{i} , {𝒳}^{j} 〉}^{2}}{2 {σ}^{2}} ) )}^{2} + {α}_{4} {‖ {Y}_{S} - {Y}_{S}^{init} ‖}_{F}^{2} + {α}_{5} {\sum }_{i , j} {S}_{i , j} {‖ {Y}_{S} ( : , i ) - {Y}_{N}^{init} ( : , j ) ‖}^{2} \qquad ( Equation 12 )$$

$$s . t . {Y}_{S}^{T} 1 = 1 , {Y}_{S} \geq 0 , S \geq 0.$$

As can be understood from the foregoing description, the optimization framework of equation 12 includes tensor classification with feature selection (e.g., equation 6) at the first and second lines of equation 12 and includes a Gaussian kernel function for measuring data similarity (e.g., equation 11) at the third and fourth lines of equation 12. In embodiments, the label rectification module 250 of FIG. 2 solves the optimization framework of equation 12 and generate re-labeled training data using the values of the records X=[X_{S}, X_{N}] and initial labels Y=[Y_{S}^{init}, Y_{N}^{init}] and parameter estimation techniques. The result of solving the optimization problem provided by equation 12 is a rectified label vector Y_{S} that contains labels for the instances of X_{S}, where Y_{S}≠Y_{S}^{init} because one or more of the initial labels has been changed. In embodiments, the label rectification module 250 of FIG. 2 creates rectified labeled training data and thus re-labeled training data comprising (X,Y) where X=[X_{S},X_{N}] are the instances of sensor data and Y=[Y_{S}, Y_{N}^{init}] are the labels for the instances of sensor data, and where the labels include the initial labels Y_{N}^{init} for the instances in the second region and the rectified labels Y_{S} for the instances in the first region.

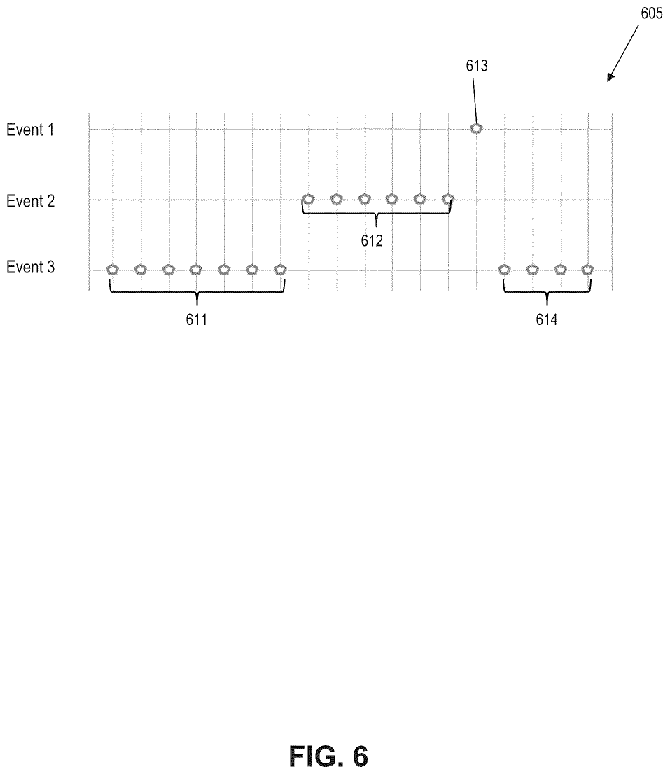

FIG. 6 shows an example of maintaining temporal consistency for noisy data in accordance with aspects of the invention. FIG. 6 shows a plot 605 in which data instances are plotted against three different labels, Event 1, Event 2, or Event 3, on the vertical axis. Each of the instances in the first group 611 has the label Event 3. Each of the instances in the second group 612 has the label Event 2. Each of the instances in the third group 613 has the label Event 1. Each of the instances in the fourth group 614 has the label Event 3.

In implementations, the optimization framework handles noisy data by constraining label fluctuations for the data instances X_{S}. In embodiments, the optimization framework is configured such that multiple label switches are penalized. In one example, when the total number of switches over time is n, a penalty is assigned to an error function which increases the value of n. In embodiments, the optimization framework is configured to set a lower bound for the number of timestamps for the consecutive instances with the same event labels. User feedback in label correction with domain knowledge may be modeled as G(Y_{S})=0. In embodiments, the optimization framework uses equations 13 and 14 to model event switches. In the following equations, uᵢⱼ:=1 if the i-th event starts up in the j-th instance and equals 0 otherwise. In the following equations, vᵢⱼ:=1 if the i-th event shuts down in the j-th instance and equals 0 otherwise. In the following equations, lᵤₚ is the minimum up time for each event. In embodiments, the optimization framework is configured to minimize the number of switches between selected events where the logical relationship between the variables Y, u, v (Y=Y_{S}) is given by equation 13:

$${Y}_{ij} - {Y}_{i , j - 1} = {u}_{ij} - {υ}_{ij} , {Y}_{ij} ∈ \{ 0 , 1 \} , ∀ i , j \qquad ( Equation 13 )$$

$${u}_{ij} + {υ}_{ij} \leq 1 , ∀ ij = 1 , … , N$$

$${u}_{i , 1} = {υ}_{i , 1} = 0 , ∀ i .$$

In embodiments, the optimization framework is configured such that if an event is selected, then it must be used for at least lᵤₚ consecutive timestamps, which results in equation 14:

$${\sum }_{k = j - {l}_{up} + 1}^{j} {u}_{ik} \leq {Y}_{ij} , ∀ i = 1 , … , M , j = {l}_{up} + 1 , … , N \qquad ( Equation 14 )$$

$${l}_{up} {Y}_{i , 1} \leq {\sum }_{j = 1}^{{l}_{up}} {Y}_{i , j} , ∀ i = 1 , … , M$$

$${l}_{up} {Y}_{i , 1} \leq {\sum }_{k = j - {l}_{up} + 1}^{j} {Y}_{i , j} , ∀ i = 1 , … , M .$$

Equations 13 and 14 provide a mechanism for reducing the number of fluctuations between different labels in the data instances. In embodiments, the optimization framework comprises equation 12 combined with equations 13 and 14, such that labels may be re-labeled to reduce the number of switches.

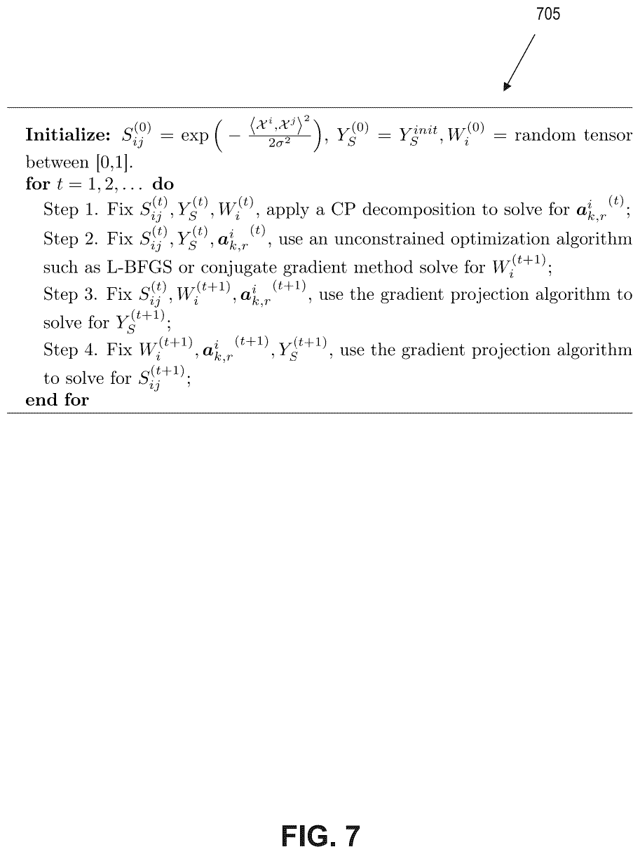

FIG. 7 shows a decomposition algorithm used for training the optimization framework given by equation 12 in accordance with aspects of the invention. In embodiments, the label rectification module 250 of FIG. 2 solves the optimization framework of equation 12 using the values of the records X=[X_{S},X_{N}] and initial labels Y=[Y_{S}^{init},Y_{N}^{init}] and the decomposition algorithm 705. As shown in FIG. 7, the algorithm 705 includes applying CP decomposition at step 1 to solve for vectors a_{k,r}ⁱ(t) of equation 5. Step 2 of the algorithm 705 includes using an unconstrained optimization algorithm, such as limited-memory BFGS or a conjugate gradient method to solve for the weight tensor Wᵢ^{(t+1)} of equation 5, where limited-memory BFGS is an optimization algorithm in the family of quasi-Newton methods that approximates the Broyden-Fletcher-Goldfarb-Shanno (BFGS) algorithm using a limited amount of computer memory. Step 3 of the algorithm 705 uses the gradient projection algorithm to solve for Y_{S}^{(t+1)} and step 4 of the algorithm 705 uses the gradient projection algorithm to solve for Sᵢⱼ^{(t+1)}. In this manner, by iterating through t=1, 2, . . . , the algorithm can be used to solve for a rectified label vector Y_{S} that contains labels for the instances of X_{S}. And, as described herein, the label rectification module 250 of FIG. 2 may then use the rectified label vector Y_{S} to create rectified labeled training data and thus re-labeled training data comprising (X,Y) where X=[X_{S},X_{N}] are the instances of sensor data and Y=[Y_{S}, Y_{N}^{init}].

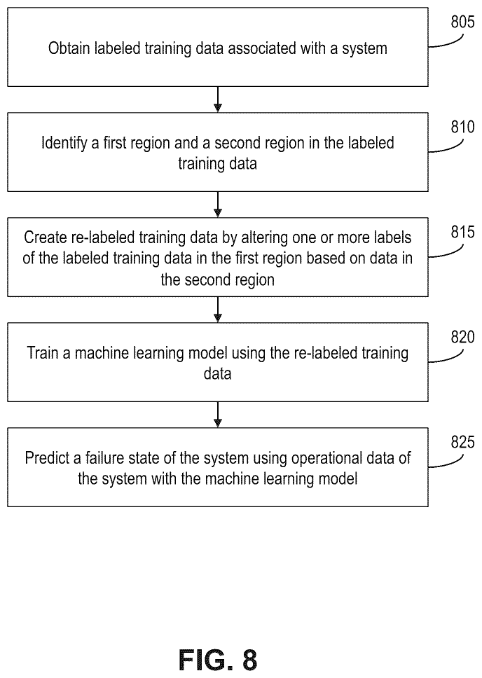

FIG. 8 shows a flowchart of an exemplary method in accordance with aspects of the present invention. Steps of the method may be carried out in the environment of FIG. 2 and are described with reference to elements depicted in FIG. 2.

At step 805, the system obtains labeled training data associated with a system. In embodiments, and as described with respect to FIGS. 2-4, the data obtention module 245 obtains labeled training data.

At step 810, the system identifies a first region in the labeled training data and a second region in the labeled training data. In embodiments, and as described above with respect to FIG. 4, the first region 411 is defined by a number of timestamps prior to the failure time “t” and the second region 412 comprises timestamps prior to the first region. In embodiments, and as described above with respect to equations 1 and 2, the labeled training data has N₁+N₂ number of samples, where N₁ is the number of instances of X that are in the first region 411 and where N₂ is the number of instances of X that are in the second region 412. In embodiments, the label rectification module 250 identifies the records in each region 411, 412 by comparing the timestamps of the individual records of the labeled training data to the failure time “t” and the predefined amount of time that defines the first region 411.

At step 815, the system creates rectified labeled training data and thus re-labeled training data by altering one or more labels of the labeled training data in the first region based on data in the second region. In embodiments, and as described above, the label rectification module 250 of FIG. 2 solves the optimization framework of equation 12 using the values and initial labels of the labeled training data (from step 805) and the algorithm 705. As described herein, solving the optimization framework of equation 12 provides a rectified label vector Y_{S} that contains labels for the instances of X_{S}, where Y_{S}≠Y_{S}^{init} because one or more of the initial labels has been changed while solving the optimization framework. In embodiments, and as described herein, the label rectification module 250 uses the rectified label vector Y_{S} to create rectified labeled training data and thus re-labeled training data comprising (X,Y) where X=[X_{S},X_{N}] are the instances of sensor data and Y=[Y_{S},Y_{N}^{init}].

At step 820, the system trains a machine learning model using the rectified and re-labeled training data from step 815. In embodiments, and as described above with respect to FIG. 2, the model training module 255 trains a predictive machine learning model using the rectified and re-labeled training data labeled training data from step 815.

At step 825, the system predicts a failure state of the system using operational data of the system with the machine learning model. In embodiments, and as described above with respect to FIG. 2, the prediction module 260 uses the trained machine learning model (from step 820) to predict a failure state of a system. In embodiments, the system comprises an industrial asset 225 equipped with one or more sensors 220, and the labeled training data (from step 805) includes time series data or tensor data obtained from the one or more sensors.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a processor set, labeled training data associated with a system;
identifying, by the processor set, a first region and a second region in the labeled training data, wherein the first region is associated with a failure of the system and the second region is exclusive of the first region; and
creating, by the processor set, re-labeled training data by altering one or more labels of the labeled training data in the first region based on data in the second region.

2. The method of claim 1, wherein the creating re-labeled training data comprises solving an optimization framework using feature values and initial labels of the labeled training data.

3. The method of claim 2, wherein the optimization framework comprises tensor classification with canonical polyadic (CP) decomposition.

4. The method of claim 2, wherein the optimization framework comprises a symmetric cross-entropy loss and a Gaussian kernel function.

5. The method of claim 2, wherein the optimization framework comprises feature selection based on group sparsity.

6. The method of claim 2, wherein the optimization framework comprises:
a rank-one tensors approximation multi-class classification with symmetric cross-entropy loss;
a group sparsity for selecting relevant features; and
a Gaussian kernel function for measuring data similarity between two tensors.

7. The method of claim 2, wherein the optimization framework is further configured to maintain label temporal consistency for noisy data by minimizing event label switches.

8. The method of claim 1, further comprising training the optimization framework using a decomposition algorithm.

9. The method of claim 1, further comprising receiving user input regarding initial labels of the labeled training data, wherein the altering one or more labels of the labeled training data in the first region based on data in the second region is further based on the user input.

10. The method of claim 1, further comprising:
training a machine learning model using the re-labeled training data; and
predicting a failure state of the system using operational data of the system with the machine learning model.

11. The method of claim 1, wherein:
the system comprises an industrial asset equipped with one or more sensors; and
the labeled training data includes time series data or tensor data obtained from the one or more sensors.

12. A computer program product comprising one or more computer readable storage media having program instructions collectively stored on the one or more computer readable storage media, the program instructions executable to:
obtain labeled training data associated with a system;
identify a first region and a second region in the labeled training data, wherein the first region is associated with a failure of the system and the second region is exclusive of the first region; and
create re-labeled training data by altering one or more labels of the labeled training data in the first region based on data in the second region.

13. The computer program product of claim 12, wherein the creating re-labeled training data comprises solving an optimization framework using feature values and initial labels of the labeled training data.

14. The computer program product of claim 13, wherein the optimization framework comprises:
a rank-one tensors approximation multi-class classification with symmetric cross-entropy loss;
a group sparsity for selecting relevant features; and
a Gaussian kernel function for measuring data similarity between two tensors.

15. The computer program product of claim 14, wherein the optimization framework is configured to maintain label temporal consistency for noisy data by minimizing event label switches.

16. The computer program product of claim 12, wherein the program instructions are executable to:
train a machine learning model using the re-labeled training data; and
predict a failure state of the system using operational data of the system with the machine learning model.

17. A system comprising:
a processor set, one or more computer readable storage media, and program instructions collectively stored on the one or more computer readable storage media, the program instructions executable to:
obtain labeled training data associated with a system;
identify a first region and a second region in the labeled training data, wherein the first region is associated with a failure of the system and the second region is exclusive of the first region; and
create re-labeled training data by altering one or more labels of the labeled training data in the first region based on data in the second region.

18. The system of claim 17, wherein:
the creating re-labeled training data comprises solving an optimization framework using feature values and initial labels of the labeled training data; and
the optimization framework comprises:
a rank-one tensors approximation multi-class classification with symmetric cross-entropy loss;
a group sparsity for selecting relevant features; and
a Gaussian kernel function for measuring data similarity between two tensors.

19. The system of claim 18, wherein the optimization framework is configured to maintain label temporal consistency for noisy data by minimizing event label switches.

20. The system of claim 17, wherein the program instructions are executable to:
train a machine learning model using the re-labeled training data; and
predict a failure state of the system using operational data of the system with the machine learning model.
